(19) United States
(12) Patent Application Publication
(10) Pub. No.: US 2007/0036632 A1
(43) Pub. Date: Feb. 15, 2007

(54) Screw having a head formed with an inner standard square recess part and an outer guiding recess part

(75) Inventor: Chao-Wei Lin, Tainan City (TW)

Correspondence Address: FROMMER LAWRENCE & HAUG, 745 FIFTH AVENUE- 10TH FL., NEW YORK, NY, 10151, US

(73) Assignee: KWANTEX RESEARCH INC.

(21) Appl. No.: 11/202,569

(22) Filed: Aug. 12, 2005

(51) Int. Cl. F16B 23/00

(52) U.S. Cl. 411/402

(57) ABSTRACT

A screw includes a head and a threaded shank that extends from one side of the head. The head further has a tool engaging side that is opposite to the shank and that has an outer peripheral edge part. The tool engaging side is formed with an inner standard square recess part that is surrounded by the outer peripheral edge part, and an outer guiding recess part that diverges from the inner standard square recess part in a direction away from the threaded shank and that is defined by a guiding surface extending from a periphery of the inner standard square recess part to the outer peripheral edge part.

### BACKGROUND OF THE INVENTION

1. Field of the Invention

The invention relates to a screw, more particularly to a screw having an improved recess configuration in a head thereof.

2. Description of the Related Art

Referring to FIGS. 1 and 2, a conventional screw 1 is shown to include a head 11 having a flat circular top surface 12 formed with a standard square recess 13 to engage a tool (not shown) . However, because the circular top surface 12 of the head 11 is flat and lacks a tool guiding function, when the conventional screw 1 is disposed in a deep hole in a wood block, and a tool is extended into the hole and blocks viewing of the recess 13, it is required to manipulate the tool repeatedly in order to engage a tip of the tool with the recess 13, thereby resulting in inconvenience.

### SUMMARY OF THE INVENTION

Therefore, the object of the present invention is to provide a screw having an improved recess configuration in a head thereof that facilitates engagement with a tip of a tool.

According to the present invention, a screw comprises a head and a threaded shank that extends from one side of the head. The head further has a tool engaging side that is opposite to the threaded shank and that has an outer peripheral edge part. The tool engaging side is formed with an inner standard square recess part that is surrounded by the outer peripheral edge part, and an outer guiding recess part that diverges from the inner standard square recess part in a direction away from the threaded shank and that is defined by a guiding surface extending from a periphery of the inner standard square recess part to the outer peripheral edge part.

### BRIEF DESCRIPTION OF THE DRAWINGS

Other features and advantages of the present invention will become apparent in the following detailed description of the preferred embodiments with reference to the accompanying drawings, of which:

FIG. 1 is a longitudinal sectional view of a conventional screw;

FIG. 2 is a schematic top view of the conventional screw;

FIG. 3 is a perspective view of the first preferred embodiment of a screw according to the present invention;

FIG. 4 is a schematic side view of the first preferred embodiment;

FIG. 5 is a schematic view to illustrate how inner and outer recess parts are formed in a head of the screw of the first preferred embodiment;

FIG. 6 is a schematic view to illustrate the first preferred embodiment in a state of use;

FIG. 7 is a perspective view of the second preferred embodiment of a screw according to the present invention; and

FIG. 8 is a schematic side view of the second preferred embodiment.

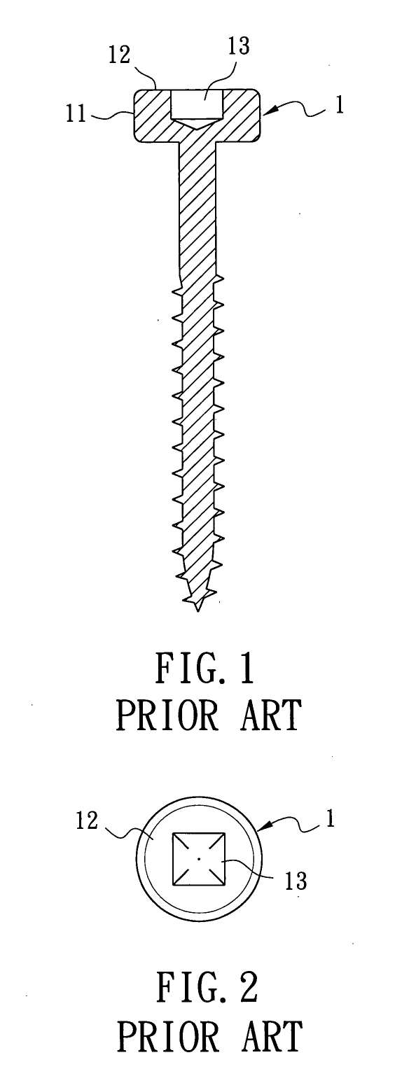

### DETAILED DESCRIPTION OF THE PREFERRED EMBODIMENTS

Before the present invention is described in greater detail, it should be noted that like elements are denoted by the same reference numerals throughout the disclosure.

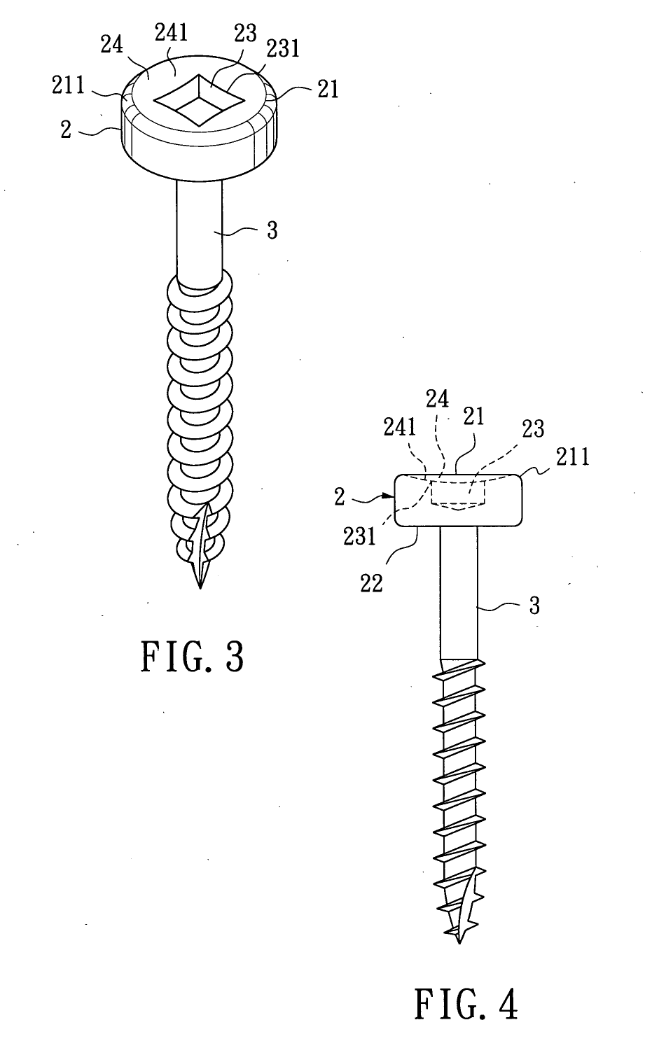

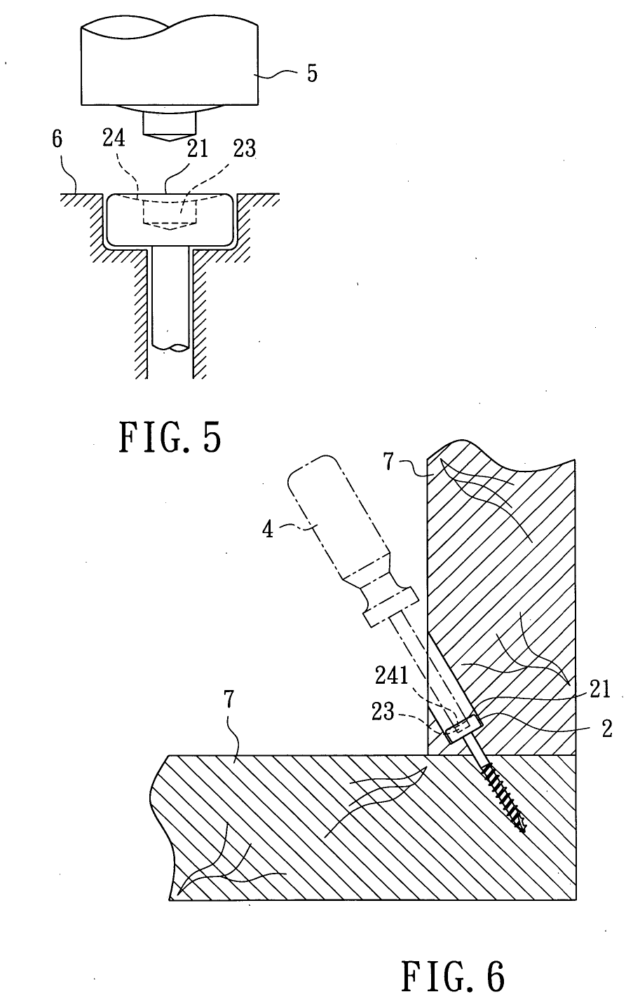

Referring to FIGS. 3 and 4, the first preferred embodiment of a screw according to the present invention is shown to include a head 2 and a threaded shank 3 that extends from one side 22 of the head 2. The head 2 further has a tool engaging side 21 that is opposite to the threaded shank 3 and that has an outer peripheral edge part 211. The tool engaging side 21 is formed with an inner standard square recess part 23 that is surrounded by the outer peripheral edge part 211, and an outer guiding recess part 24 that diverges from the inner standard square recess part 23 in a direction away from the threaded shank 3 and that is defined by a guiding surface 241 extending from four sides 231 of the inner standard square recess part 23 to the outer peripheral edge part 211. In this embodiment, the guiding surface 241 is a concave surface. As best shown in FIG. 6, in view of the guiding surface 241, the relative tip of a tool 4 can be guided into the inner standard square recess part 23.

Referring to FIG. 5, the inner standard square recess part 23 and the outer guiding recess part 24 can be formed in a single-step forging operation to minimize material consumption and to optimize product yield. The forging operation employs a female mold part 6 that is used to position the head 2 of the screw, and a male mold part 5 that is used to form the inner standard square recess part 23 and the outer guiding recess part 24 in the tool engaging side 21 of the head 2 of the screw.

FIG. 6 illustrates the screw of the first preferred embodiment when used to fasten two wood blocks 7. Because the guiding surface 241 can guide the tip of the tool 4, when the screw of the first preferred embodiment is disposed in a deep hole in one of the wood blocks 7, and the tool 4 is extended into the hole such that viewing of the inner standard square recess part 23 is blocked by the tool 4, the tip of the tool 4 can be guided by the guiding surface 241 to engage the inner standard square recess part 23 in a quick and convenient manner.

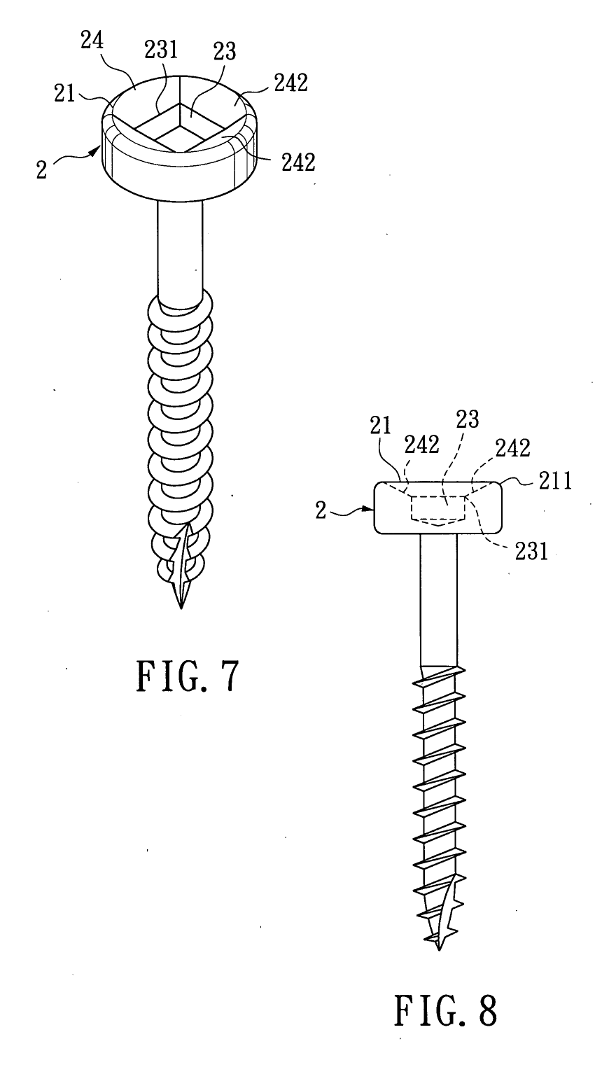

FIGS. 7 and 8 illustrate the second preferred embodiment of a screw according to this invention, which differs from the previous embodiment primarily in the configuration of the guiding surface that defines the outer guiding recess part 24. In this embodiment, the guiding surface includes four inclined flat surface segments 242, each of which extends from a respective side 231 of the inner standard square recess part 23 to the outer peripheral edge part 211.

It should be noted herein that the actual shape of the inner standard square recess part 23 is not limited to that illustrated in the accompanying drawings, and can be any other suitable standard recess, such as 6-lobes, Phillips compound recess, etc.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A screw comprising a head and a threaded shank that extends from one side of said head, said head further having a tool—engaging side that is opposite to said threaded shank and that has an outer peripheral edge part, said tool—engaging side being formed with an inner standard square recess part that is surrounded by said outer peripheral edge part, and an outer guiding recess part that diverges from said inner standard square recess part in a direction away from said threaded shank and that is defined by a concave guiding surface extending from a periphery of said inner standard square recess part to said outer peripheral edge part.

2. (Canceled)

3. (Canceled)
